(19) United States
(12) Patent Application Publication
(10) Pub. No.: US 2021/0034146 A1
(43) Pub. Date: Feb. 4, 2021

(54) EYE TRACKING WITH RECORDED VIDEO CONFIRMATION OF FACE IMAGE UPON ACCEPTING TERMS

(71) Applicant: Sony Interactive Entertainment Inc., Tokyo (JP)

(72) Inventor: Todd Tokubo, San Mateo, CA (US)

(21) Appl. No.: 16/528,527

(22) Filed: Jul. 31, 2019

(51) Int. Cl. G06F 3/01; G06F 9/54; G06Q 10/10

(52) U.S. Cl. CPC G06F 3/013; G06Q 10/10; G06F 9/542; G06F 3/017

(57) ABSTRACT

Eye tracking based on images from a camera juxtaposed with a computer such as a display thereof is used to ensure that a user reads a legal document or disclaimer. To ensure the identity of the user accepting the terms, a video confirmation of the user's face image (or other unique identifier such as a retinal fingerprint) can be recorded responsive to the user accepting the terms.

### FIELD

The present application relates to technically inventive, non-routine text-to-speech solutions that are necessarily rooted in computer technology and that produce concrete technical improvements.

### BACKGROUND

As recognized herein, computer users are often required to read legal terms and conditions or disclaimers when accessing certain websites, and currently indicate having done so by clicking an acknowledgement button. Without clicking the button, the user is denied access. As also understood herein, however, this practice does not ensure that the user really has read the subject matter before clicking through to access the site, or that the person who clicks on the acknowledgement button is the known user or owner of the computer.

There are currently no adequate solutions to the foregoing computer-related, technological problem.

### SUMMARY

Eye tracking is used to ensure that a user reads a legal document or disclaimer, with a video confirmation of the user's face image (or other unique optical identifier) being recorded upon the user accepting the terms.

Accordingly, a device includes at least one processor and at least one computer memory that is not a transitory signal and that in turn includes instructions executable by the processor to present alpha-numeric terms in at least a first region of a display and execute eye tracking of at least a first user. The instructions are executable to receive input indicating receive input indicating at least partial viewing of the terms, and responsive to the eye tracking indicating that the user satisfied at least one condition with respect to viewing the terms, record at least biometric attribute of the user. Further, the instructions are executable to, responsive to the eye tracking not indicating that the user satisfied at least one condition with respect to viewing the terms, not grant access to at least a first computer function responsive to the input indicating acceptance of the terms. That is, even if the user clicks on “accept” or “acknowledge”, if the eye tracking indicates that the user has not adequately read the terms, acceptance of the terms may be declined.

The terms may include a legal document or disclaimer. The first region in which the terms are presented may encompass the entire display or only a portion of the display.

In example embodiments, the condition with respect to viewing the terms can include viewing of the first region for at least a first period. In example embodiments, the condition with respect to viewing the terms can include viewing of at least a first area of the first region. In example embodiments, the condition with respect to viewing the terms can include viewing of the first region with at least a first eye movement. One or more of these example conditions may be used in combination.

In some implementations, the instructions may be executable to, responsive to the eye tracking indicating that the user satisfied at least one condition with respect to viewing the terms, grant access to at least a first computer function responsive to the input indicating acceptance of the terms. In some examples, the instructions are executable to, responsive to the eye tracking not indicating that the user satisfied at least one condition with respect to viewing the terms, present a prompt for the user to read the terms responsive to the input indicating acceptance of the terms.

In another aspect, an apparatus includes at least one computer readable storage medium that is not a transitory signal and that includes instructions executable by at least one processor to use eye tracking based on images from a camera juxtaposed with a display to ensure that a user reads a legal document or disclaimer. The instructions are executable to ensure an identity of the user at least partially reading terms of the legal document or disclaimer by recording a biometric attribute of the user. The biometric attribute may be a photograph of the user's face, a voice print, a fingerprint, a retinal print, or other biometric attribute, and may be obtained responsive to the user accepting the terms or disclaimer.

In another aspect, a method includes executing eye tracking of at least one user viewing a computer display, and during the eye tracking, presenting on the computer display terms of use. The method includes, responsive to input of a signal indicating at least partial reading of the terms of use, with the signal being at least in part based on the eye tracking, selectively granting access to at least one computer function.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a schematic diagram illustrating eye tracking of a user to determine whether the user has read legal terms responsive to the user inputting a signal indicating that the user has read the terms;

FIG. 3 is a flow chart of example logic consistent with present principles;

FIG. 4 is a screen shot of an example user interface (UI) that may be presented responsive to receipt of an acknowledgement signal but the eye tracking indicating that the user did not adequately read the terms, consistent with present principles; and

FIG. 5 is a screen shot of an example UI that may be presented initially prior to presenting the terms to enable a user to opt into the eye tracking technique, consistent with present principles.

### DETAILED DESCRIPTION

This disclosure relates generally to computer ecosystems including aspects of computer networks that may include consumer electronics (CE) devices. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library. While flow chart format may be used, it is to be understood that software may be implemented as a state machine or other logical method.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C # or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

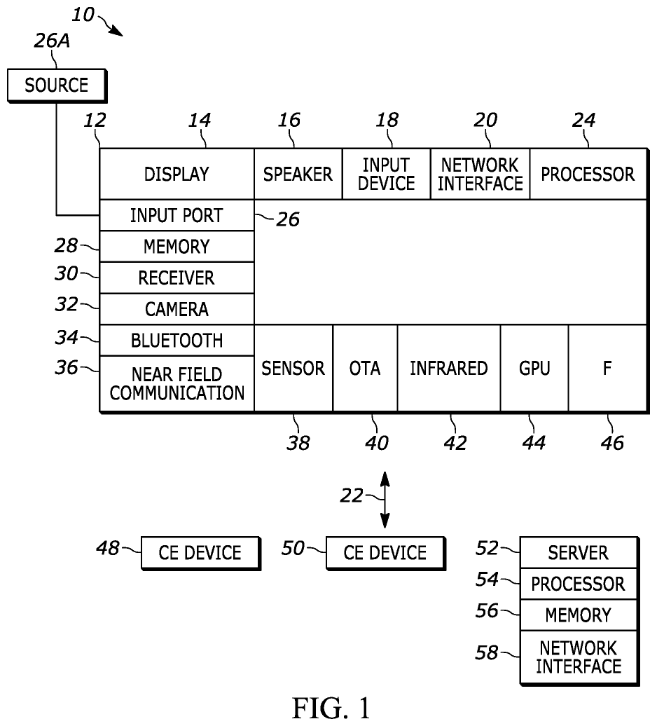

Now specifically referring to FIG. 1, an example system 10 is shown, which may include one or more of the example devices mentioned above and described further below in accordance with present principles. The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). The AVDD 12 may be an Android®-based system. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 and/or other computers described herein is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may or may not be touch-enabled for receiving user input signals via touches on the display. The AVDD 12 may also include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may further include one or more network interfaces 20 for communication over at least one network 22 such as the Internet, a WAN, an LAN, a PAN etc. under control of one or more processors 24. Thus, the interface 20 may be, without limitation, a Wi-Fi transceiver, which is an example of a wireless computer network interface, such as but not limited to a mesh network transceiver. The interface 20 may be, without limitation a Bluetooth transceiver, Zigbee transceiver, IrDA transceiver, Wireless USB transceiver, wired USB, wired LAN, Powerline or MoCA. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player.

The AVDD 12 may further include one or more computer memories 28 such as disk-based or solid-state storage that are not transitory signals, in some cases embodied in the chassis of the AVDD as standalone devices or as a personal video recording device (PVR) or video disk player either internal or external to the chassis of the AVDD for playing back AV programs or as removable memory media. Also, in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 38 (e.g., a motion sensor such as an accelerometer, gyroscope, cyclometer, or a magnetic sensor, an infrared (IR) sensor for receiving IR commands from a remote control, an optical sensor, a speed and/or cadence sensor, a gesture sensor (e.g. for sensing gesture command), etc.) providing input to the processor 24. The AVDD 12 may include an over-the-air TV broadcast port 40 for receiving OTA TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still further, in some embodiments the AVDD 12 may include a graphics processing unit (GPU) 44 and/or a field-programmable gate array (FPGA) 46. The GPU and/or FPGA may be utilized by the AVDD 12 for, e.g., artificial intelligence processing such as training neural networks and performing the operations (e.g., inferences) of neural networks in accordance with present principles. However, note that the processor 24 may also be used for artificial intelligence processing such as where the processor 24 might be a central processing unit (CPU).

Still referring to FIG. 1, in addition to the AVDD 12, the system 10 may include one or more other computer device types that may include some or all of the components shown for the AVDD 12. In one example, a first device 48 and a second device 50 are shown and may include similar components as some or all of the components of the AVDD 12. Fewer or greater devices may be used than shown.

The system 10 also may include one or more servers 52. A server 52 may include at least one server processor 54, at least one computer memory 56 such as disk-based or solid state storage, and at least one network interface 58 that, under control of the server processor 54, allows for communication with the other devices of FIG. 1 over the network 22, and indeed may facilitate communication between servers, controllers, and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server and may include and perform “cloud” functions such that the devices of the system 10 may access a “cloud” environment via the server 52 in example embodiments. Or, the server 52 may be implemented by a game console or other computer in the same room as the other devices shown in FIG. 1 or nearby.

The devices described below may incorporate some or all of the elements described above.

The methods described herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the Internet.

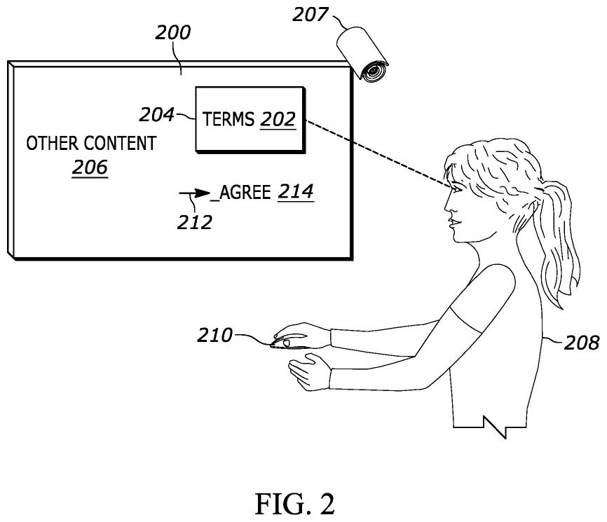

FIG. 2 shows a computer display 200 in which alpha-numeric terms 202 typically of a legal document and/or disclaimer are presented in a region 204 of the display 200. The region 204 may be only part of the entire display area as shown, such that other content 206 may also be presented on the display 200 along with the terms 202, or the region 204 may encompass the entire display area of the display 200.

Images from one or more cameras 207 such as a video camera that is mounted on or otherwise closely juxtaposed with the display 200 (in other words, is located to be able to track the eyes of a user viewing the display) are used to execute eye tracking of a user 208. The user 208 may use an input device such as but not limited to a mouse 210 to move a screen cursor 212 as appropriate to a selector 214 and click the mouse 210 to indicate acceptance or acknowledgement (used interchangeably herein) of the terms 202.

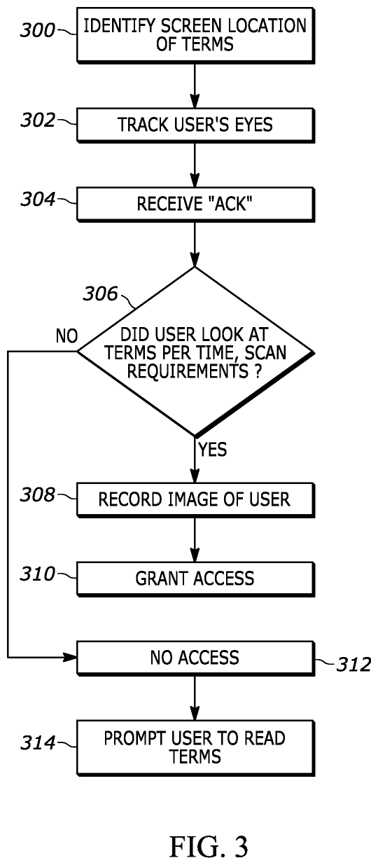

FIG. 3 illustrates principles for using the eye tracking based on the images from the camera 207. Commencing at block 300, the screen location of the region 204 in which the terms 202 are presented is identified. Typically, the software presenting the terms dictates the location at which the terms 202 are presented.

Moving to block 302, using images from the camera 207 the user's eyes are tracked to determine the direction and, hence, the portion of the display 200 at which the user is looking. In non-limiting examples, eye tracking may be executed by noting the location of the darker iris compare to the whiter sclera and deriving a direction of gaze therefrom.

Eye tracking thus can be used alone to determine whether the user has at least partially read the terms and conditions in a manner that satisfies conditions for accessing further computer functions. However, in some examples block 304 indicates that input may be received (e.g., a click of the mouse 210) indicating acceptance of the terms 202. If desired however, indicating acceptance of the terms, while typically unlocking access to computer functions such as access to a web page, does not automatically result in access unless it is determined at decision diamond 306 that the eye tracking from block 302 indicates that the user satisfied at least one condition with respect to viewing the terms. If so, an image of the user's face from the camera 207 may be recorded at block 308 responsive to the input at block 304 and access to appropriate computer functions granted at block 310. Note that an image of the face is an example of a biometric attribute of the user that may be recorded to confirm identity. Other biometric attributes may be used, e.g., retinal scan fingerprint based on images from the camera 207 or other camera, voice print, fingerprint, etc. Indeed, if desired non-biometric identity may be recorded, e.g., code from a user's near field identification (NFID) device, or a passcode input by the user, etc.

However, responsive to the eye tracking not indicating that the user satisfied at least one condition with respect to viewing the terms, access to the computer function is denied at block 312 even though the input was received indicating acceptance of the terms. The user may be prompted at block 314 to read or reread the terms.

Note that implementations may not use the above-described logic in the order presented. For example, eye tracking may be evaluated at decision diamond 306 prior to receiving acceptance input at block 304, and as mentioned above, acceptance input may be omitted as an affirmative step and images from the camera 207 used to infer that the user has read the terms, at least partially in a manner satisfying a threshold, and that further user input or use may be assumed to infer acceptance.

One or more viewing conditions may be used at decision diamond 306 to evaluate whether eye tracking indicates reading of the terms 202. As one example, the condition with respect to viewing the terms may include determining whether the user viewed the region 204 for at least a threshold period, e.g., a few seconds. As another example, the condition with respect to viewing the terms may include determining whether the user viewed at least a threshold area or percentage (less than 100%) of the region 204.

As yet another example, the condition with respect to viewing the terms may include determining whether the user viewed the region with at least a threshold eye movement. For instance, eye tracking may be used to determine that the user statically looked at the region 204 for a threshold period of time but also that during the period of looking at the region 204, the user's eyes also moved left to right and back again, if desired by a threshold angle or distance, a threshold number of times, for a dynamic indication of reading.

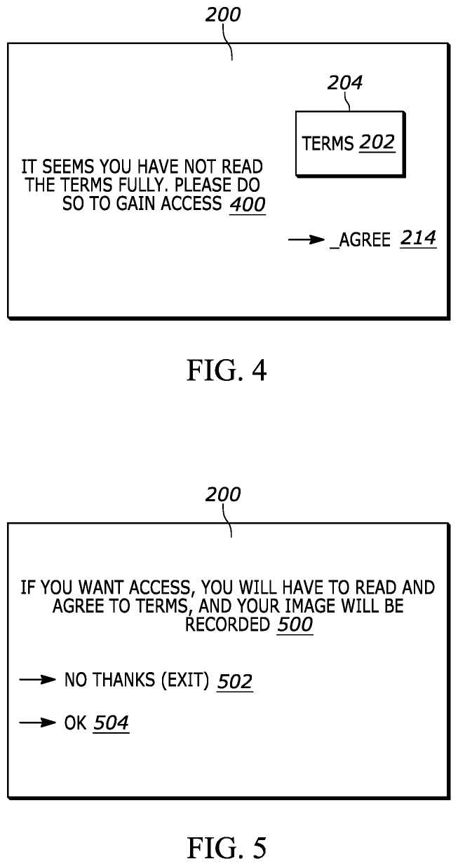

FIG. 4 illustrates a UI that, as discussed above in relation to block 314 of FIG. 3, presents a prompt 400 for the user to read the terms responsive to the input indicating acceptance of the terms, responsive to the eye tracking not indicating that the user satisfied at least one condition with respect to viewing the terms.

FIG. 5 illustrates a UI that may be presented on the display 200 prior to executing the logic of FIG. 3, to allow a user to opt out of having his eyes tracked and image recording (which typically results in being locked out of the associated computer function sought to be accessed). A prompt 500 may be presented indicating that to gain access, the user must read the terms 202 and agree to them, and will have his image recorded. The user may select a decline selector 502 to decline or an acceptance selector 504 to accept, at which point the logic of FIG. 3 may commence.

It will be appreciated that whilst present principals have been described with reference to some example embodiments, these are not intended to be limiting, and that various alternative arrangements may be used to implement the subject matter claimed herein.

1. A device, comprising:
at least one processor configured with instructions executable by the at least one processor to:
present alpha-numeric terms in at least a first region of a display;
execute eye tracking of at least a first user;
receive input indicating at least partial viewing of the terms;
responsive to the eye tracking indicating that the user satisfied at least one condition with respect to viewing the terms, record at least biometric attribute of the user; and
responsive to the eye tracking not indicating that the user satisfied at least one condition with respect to viewing the terms, not grant access to at least a first computer function responsive to the input indicating acceptance of the terms and not record at least one biometric attribute.

2. The device of claim 1, wherein the terms comprise a legal document.

3. The device of claim 1, wherein the terms comprise a disclaimer.

4. The device of claim 1, wherein the first region comprises an entire presentation region of the display.

5. The device of claim 1, wherein the display comprises the first region and a second region in which content is presentable.

6. The device of claim 1, wherein the at least one condition with respect to viewing the terms comprises viewing of the first region for at least a first period.

7. The device of claim 1, wherein the at least one condition with respect to viewing the terms comprises viewing of at least a first area of the first region.

8. The device of claim 1, wherein the at least one condition with respect to viewing the terms comprises viewing of the first region with at least a first eye movement.

9. The device of claim 1, wherein the instructions are executable to:
responsive to the eye tracking indicating that the user satisfied at least one condition with respect to viewing the terms, grant access to at least a first computer function responsive to the input indicating acceptance of the terms.

10. The device of claim 1, wherein the instructions are executable to:
responsive to the eye tracking not indicating that the user satisfied at least one condition with respect to viewing the terms, present a prompt for the user to read the terms responsive to the input indicating acceptance of the terms.

11. An apparatus, comprising:
at least one computer readable storage medium that is not a transitory signal, the at least one computer readable storage medium comprising instructions executable by at least one processor to:
use eye tracking based on images from a camera juxtaposed with a display to ensure that a user reads a legal document or disclaimer; and
to ensure an identity of the user at least partially reading terms of the legal document or disclaimer, record a biometric attribute of the user during the eye tracking.

12. The apparatus of claim 11, wherein the instructions are executable to:
receive input indicating acceptance of the terms;
responsive to the eye tracking indicating that the user satisfied at least one condition with respect to viewing the terms, record at least one image of the user; and
responsive to the eye tracking not indicating that the user satisfied at least one condition with respect to viewing the terms, not grant access to at least a first computer function responsive to the input indicating acceptance of the terms.

13. The apparatus of claim 11, wherein a region in which the terms are presented encompasses an entire presentation region of the display.

14. The apparatus of claim 11, wherein a region in which the terms are presented does not encompass an entire presentation region of the display.

15. The apparatus of claim 12, wherein the at least one condition with respect to viewing the terms comprises viewing of the terms for at least a first period.

16. The apparatus of claim 12, wherein the at least one condition with respect to viewing the terms comprises viewing of at least a first area of the terms.

17. The apparatus of claim 12, wherein the at least one condition with respect to viewing the terms comprises viewing of the first region with at least a first eye movement.

18. The apparatus of claim 12, wherein the instructions are executable to:
responsive to the eye tracking indicating that the user satisfied at least one condition with respect to viewing the terms, grant access to at least a first computer function responsive to the input indicating acceptance of the terms.

19. The apparatus of claim 12, wherein the instructions are executable to:
responsive to the eye tracking not indicating that the user satisfied at least one condition with respect to viewing the terms, present a prompt for the user to read the terms responsive to the input indicating acceptance of the terms.

20. (canceled)
